(19) United States
(12) Patent Application Publication
(10) Pub. No.: US 2024/0426287 A1
(43) Pub. Date: Dec. 26, 2024

(54) FLUID CONTROL SYSTEM

(71) Applicant: LEE VENTUS LTD, Melbourn Royston Hertfordshire (GB)

(72) Inventors: Stuart Hatfield, Melbourn Royston Hertfordshire (GB); Tom Harrison, Melbourn Royston Hertfordshire (GB)

(21) Appl. No.: 18/708,039

(22) PCT Filed: Nov. 8, 2022
(86) PCT No.: PCT/GB2022/052815

§ 371 Date: May 7, 2024

(30) Foreign Application Priority Data
Nov. 8, 2021 (GB) 2115979.3

(51) Int. Cl. F04B 41/02; F04B 43/04; F04B 49/08

(52) U.S. Cl. CPC F04B 41/02; F04B 43/046; F04B 49/08; F04B 2205/063; F04B 2205/09

(57) ABSTRACT

A fluid control system comprising: a first channel for carrying a gas in and out of the fluid control system; a reservoir for said gas, wherein the reservoir includes a first pressure sensor arranged to measure a pressure of the gas in the reservoir; a pump for pumping said gas between the first channel and the reservoir, wherein the system is arranged such that a quantity of the gas displaced in the first channel depends on a change in pressure of the gas in the reservoir.

### CROSS REFERENCE TO RELATED APPLICATIONS

This application is a National Stage of PCT Application No. PCT/GB2022/052815 filed on Nov. 8, 2022, which claims priority to Great Britain Application No. 2115979.3 filed on Nov. 8, 2021, the contents each of which are incorporated herein by reference thereto.

### TECHNICAL FIELD

The present disclosure relates to fluid flow control and in particular to a control system for measurement and control of gas displacement, along with associated methods.

### BACKGROUND

Air pumps (and particularly highly controllable acoustic resonance pumps) have many applications which benefit from their small size, low pulsatility and highly controllable operation.

One drawback of these pumps is that they do not provide a fixed positive displacement of fluid, and so in applications requiring fixed volumes (such as aspirating and dispensing operations) or controlled flow rates (microfluidics, gas sensing) alternative technologies which provide ‘known positive displacement’ such as syringe pumps, or systems with additional architecture such as an inline flow sensor are commonly used. However, these approaches are typically expensive and increase system complexity. Even simple flow rate measurements such a differential measurement over an orifice requires extra sensors and is vulnerable to changes in the flow character (e.g. due to blocking of the orifice or changes in fluid viscosity) and may not be accurate at low flow rates.

The present disclosure seeks to address these and other disadvantages encountered in the prior art by providing an improved system for measurement and control of the displacement of gas.

### BRIEF SUMMARY

According to a first aspect of the present disclosure, there is provided a fluid control system comprising: a first channel for carrying a gas in and out of the fluid control system; a reservoir for said gas, wherein the reservoir comprises a first pressure sensor arranged to measure a pressure of the gas in the reservoir; a pump for pumping said gas between the first channel and the reservoir; wherein the system is arranged such that a quantity of the gas displaced in the first channel depends on a change in pressure of the gas in the reservoir.

The fluid control system may further comprise a controller which is arranged to be (i.e., in use) communicatively coupled to the first pressure sensor and configured to determine and/or control a quantity of the gas displaced in the first channel based on a change in pressure of the gas in the reservoir.

The controller may be configured to determine and/or control the quantity of the gas displaced in the first channel further based on: a storage volume of the reservoir in which gas can be stored.

The controller may be configured to determine and/or control a volumetric flow rate of gas in the first channel based on: a storage volume of the reservoir in which gas can be stored; and a time derivative of pressure of the gas in the reservoir.

The controller may be further configured to control the pump based on a change in pressure of the gas in the reservoir, thereby providing control of the quantity of the gas displaced in the first channel.

The pump may be adapted to displace <0.01 μL of gas per cycle or controllable step.

The pump may be a piezoelectric acoustic resonance pump.

The reservoir may comprise at least one vessel arranged to store said gas.

The vessel may have a configurable storage volume.

The vessel may comprise a plunger and barrel arrangement in order to provide the configurable storage volume.

The reservoir may comprise a plurality of vessels each of which is in fluid communication with the fluid control system via a respective valve, such that the storage volume of the reservoir can be configured using the respective valves.

The fluid control system may further comprise a second channel arranged to provide a fluid connection between the reservoir and the first channel, wherein the second channel provides a flow restriction to a flow of gas between the reservoir and the first channel.

The flow restriction provided by the second channel may be configured to support a pressure difference between the reservoir and the first channel.

The second channel may comprise a flow restrictor which is configured to provide said flow restriction to a flow of gas between the reservoir and the first channel.

The fluid control system may further comprise a valve in fluid communication with the reservoir, the valve being configured to control displacement of gas into or out of the fluid control system, without passing through the first channel, in order to decrease a pressure difference between the gas in the reservoir and the gas in the first channel.

The fluid control system may further comprise at least one temperature sensor for measuring a temperature of the gas, and the controller may be further configured to determine and/or control a quantity of the gas displaced in the first channel further based on the temperature of the gas.

The fluid control system may further comprise a second pressure sensor arranged to measure a pressure of the gas in the first channel; and the controller may, in use, be communicatively coupled to the second pressure sensor and further configured to control the pump based on measurements of pressure of the gas in the first channel.

The fluid control system may be configured to displace a predefined quantity or volume of gas in the first channel.

The fluid control system may be arranged to generate and maintain a pressure difference between the reservoir and the first channel by pumping gas between the reservoir and the first channel.

The fluid control system may be configured to create a positive or negative rate of change of pressure of the gas in the reservoir in order to cause a positive or negative volumetric flow rate of gas in the first channel.

The fluid control system may be configured to aspirate a liquid into a pipette which is in fluid communication with the first channel by increasing the pressure of the gas in the reservoir.

The fluid control system may be configured to control dispensing of the liquid from the pipette by slowing or stopping pumping of the gas from the first channel to the reservoir.

According to another aspect of the present disclosure, there is provided a method of controlling a displacement of gas by a fluid control system according to any aspect described herein, the method comprising: receiving, from the pressure sensor, measurements of pressure of the gas in the reservoir; determining a change in pressure of the gas in the reservoir; and controlling a quantity of the gas displaced in the first channel based on the change in pressure of the gas in the reservoir.

The method may further comprise: identifying a storage volume of the reservoir in which gas can be stored; and controlling the quantity of the gas displaced in the first channel further based on the storage volume of the reservoir.

The method may further comprise: determining a time derivative of pressure of the gas in the reservoir; and determining and/or controlling a volumetric flow rate of gas in the first channel based on: the storage volume of the reservoir in which gas can be stored; and the time derivative of pressure of the gas in the reservoir.

The method may further comprise: controlling the pump based on the change in pressure of the gas in the reservoir, thereby providing control of the quantity of the gas displaced in the first channel.

### BRIEF DESCRIPTION OF THE DRAWINGS

Examples will now be described, with reference to the accompanying drawings, in which:

FIG. 1 is a schematic depiction of a fluid control system according to a first example;

FIG. 2 schematically illustrates a fluid control system which additionally comprises a controller;

FIG. 3 is a schematic depiction of a fluid control system which additionally includes a leak-back connection;

FIG. 4 schematically illustrates a fluid control system which additionally includes a second pressure sensor;

FIG. 5 schematically illustrates a fluid control system which additionally includes temperature sensors as well as a venting valve;

FIG. 6 schematically illustrates a fluid control system which additionally includes a plurality of vessels;

FIG. 7 schematically illustrates a fluid control system which includes a reservoir which has an adjustable vessel;

FIG. 8 schematically illustrates a fluid control system in fluid communication with a gas-liquid unit;

FIG. 9 schematically illustrates a fluid control system in fluid communication with a pipette;

FIG. 10 depicts three simplified, corresponding graphs illustrating operation of the fluid control system according to any of the described examples;

FIG. 11 shows a similar series of simplified graphs to FIG. 10, illustrating an aspirate and dispense procedure;

FIG. 12 shows a series of simplified corresponding graphs which illustrate how directional volumetric flows can be achieved; and

FIG. 13 shows two simplified corresponding graphs which illustrate how a continuous volumetric flow of gas can be achieved.

### DETAILED DESCRIPTION

### Example 1—Overview

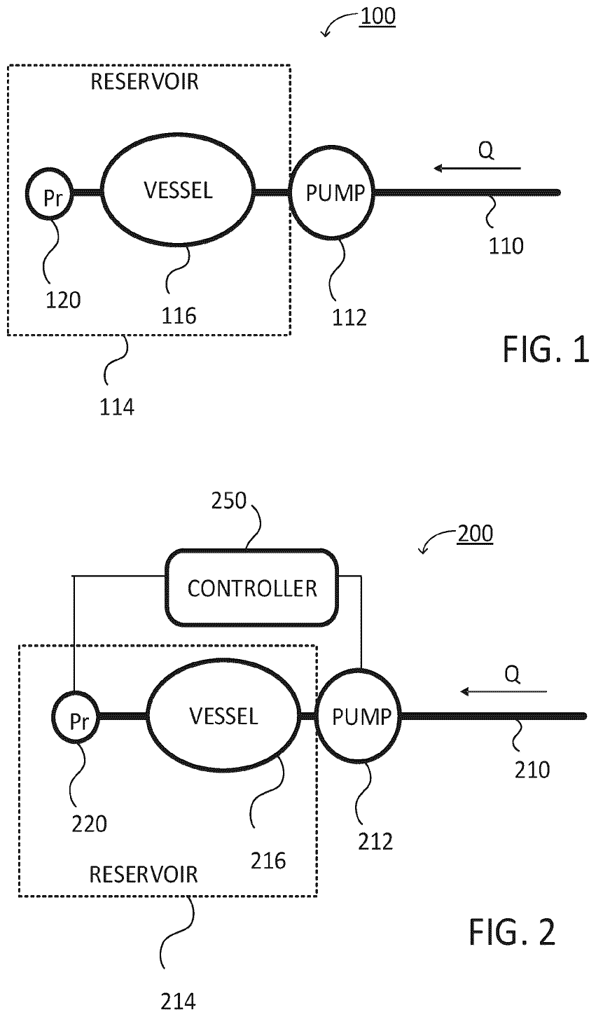

FIG. 1 is a schematic depiction of a fluid control system 100 according to a first example. As shown in FIG. 1, the fluid control system 100 includes a connecting tube 110, a pump 112 and a reservoir 114. The fluid control system 100 allows accurate flow and volumetric control of gas (e.g. air) in the connecting tube 110 by using the pump 112 to pump gas into (or out of) the reservoir 114 and by monitoring the pressure of the gas in the reservoir 114. The reservoir 114 has a known and consistent volume, and therefore the system 100 allows determination and/or control of a quantity of air (or other gas) displaced in the connecting tube 110 based on measurements of pressure of the air in the reservoir 114. Advantageously, this can be done without needing an inline flow sensor on the connecting tube 110, which avoids cost and complexity in such parts of the system 100—particularly as components connected to the connecting tube 110 are often part of an external system which cannot be reused after an application.

The fluid control system 100 is configured to use the pump 112 to create and maintain a pressure difference between the gas in the reservoir 114 and the gas in the connecting tube 110. Also, the fluid control system 100 is configured to allow gas to reversibly flow between the connecting tube 110 and the reservoir 114. This provides opportunities to store and then release pressure from the reservoir 114, as explained in more detail below.

The described examples of fluid control systems provide a low cost, reliable system for providing accurate flow and volumetric control. The fluid control system can be connected to external systems in order to control fluid in the external systems—e.g. in order to control liquid aspirating in a syringe. The fluid control system may also be referred to as a Volumetric Control Module (VCM) or pump module.

### Example 1—Connecting Tube

The connecting tube 110 acts as a channel for carrying gas in and out of the fluid control system 100. The connecting tube 110 is connected to an inlet of the pump 112 to allow gas to move between the connecting tube 110 and the pump 112. The connecting tube 110 connects the pump 112 to other components, allowing such components to be controlled using the fluid control system 100. For example, the connecting tube 110 may connect the fluid control system 100 to a pipette so that the system 100 can control an aspiration procedure in the pipette. This is described in more detail below.

### Example 1—Pump

In this example, the pump 112 is a piezoelectric acoustic resonance pump. The pump 112 may comprise a pump as described in patent publication US 20090087323A1, which is hereby incorporated by reference. Using a piezoelectric acoustic resonance pump means that the pump 112 is highly controllable, so accurate operation of the system can be achieved.

The pump 112 is controlled to pump gas into the reservoir 114 from the connecting tube 110 (or vice versa, in other examples). In this example, the pump 112 also allows “leak back” from the reservoir 114 through the pump 112 and into the connecting tube 110, generally when the pump 112 is not actively pumping. In this way, the pump 112 provides a two-way fluid connection between the connecting tube 110 and the reservoir 114 and enables storage and release of pressure from the reservoir 114.

### Example 1—Reservoir

The reservoir 114 includes a vessel 116 and a pressure sensor 120, along with interconnecting components (not shown in detail) for connecting the vessel 116 to the pressure sensor 120 and the pump 112. The vessel 116 has a known volume, V, for storing air (or other gas). The pressure sensor 120 is connected to the vessel 116 and arranged to measure gas pressure in the vessel 116 (and thus in the reservoir 114).

The reservoir 114 as a whole has a storage volume, Vᵣ. This storage volume, Vᵣ, is the total volume in which gas can be stored in the reservoir 114, taking into account all of the components on the reservoir 114 side of the pump 112. This includes the vessel 116, the pressure sensor 120 and all interconnecting components (e.g. tubes, pipes, fittings) between them. The storage volume, Vᵣ, may also include any volume within the pump 112 itself which is at the same or similar pressure to the reservoir 114, for example any volume within the pump 112 on the reservoir 114 side of any valves which support a pressure difference within the pump 112. The reservoir 114 is adapted to maintain a consistent storage volume, Vᵣ, at all typical working pressures. The vessel 116, pressure sensor 120 and connections may be substantially rigid in order to help maintain a consistent storage volume Vᵣ. Furthermore, the reservoir 114 is substantially sealed with no leaks, other than its connections and vents as described herein.

The pressure sensor 120 may include a display for indicating the measured pressure of the gas in the reservoir 114. This allows a user to determine when a target pressure has been reached.

In cases where a target pressure is surpassed, the pump 112 is controlled (by a controller or user) to slow or stop pumping. The pump 112 is designed to allow leak back through pump to decrease the difference in pressure between the reservoir 114 and the connecting tube 110.

A particular benefit of the fluid control system 100 is that it provides some reverse flow capability, which can be useful in aspirate/dispense applications, allowing a simple, low-cost solution which does not necessarily require active valves to control when stored pressure in the reservoir 114 is released to create a reverse flow. In simple terms, when the pump 112 is actively pumping then a positive (or negative) pressure can be stored in the reservoir 114, and when the pump 112 is not actively pumping then the stored pressure is released (via the pump 112 itself, or via a second connection as explained below).

### Example 1—Example Values

To achieve displacement of a target volume of gas, V_{d}, in the connecting tube 110, the pump 112 must be sufficiently powerful to increase a pressure of the gas in the reservoir, Pᵣ, to an associated target pressure, for example in accordance with the equations below.

The pump 112 should also be sufficiently accurate to control the pressure of the gas in the reservoir, Pᵣ, to a desired accuracy. Some applications which may benefit from the fluid control system 100 may target movement of volumes, V_{d}, in the connecting tube 110 of as little as a few μL with an accuracy of better than +/−1%. This requires the use of a pump 112 which can move <0.01 μL of gas per cycle or controllable step. Piezoelectric acoustic resonance pumps, such as the pump as described in patent publication US 20090087323A1, are typically capable of meeting this requirement.

Other applications which may benefit from the fluid control system 100 may target movement of volumes, V_{d}, in the connecting tube 110 of hundreds of millilitres mL up to 1 L.

The reservoir storage volume, Vᵣ, may be less than 1 L, and more preferably between 0.1 mL to 100 mL.

To minimise the physical size of the fluid control system 100, it may be desirable to minimise the storage volume, Vᵣ, of the reservoir 114 to be of approximately the same order of magnitude as the target volume to be moved. This requires that the pump 112 should be capable of generating pressure differences of many hundreds of millibar (mbar).

In general, piezoelectric pumps, and more specifically acoustic resonance pumps generate high differential pressures with smooth, controllable flow rates ideally suited for use in the fluid control system 100.

### Example 2—Overview

FIG. 2 schematically illustrates a fluid control system 200 which includes similar components to the fluid control system 100 in FIG. 1, in which the control system 200 additionally comprises a controller 250. The fluid control system 200 includes a pump 212 and a pressure sensor 220, both of which are configured to interact with the controller 250, along with a vessel 216. These components are similar to those described above and therefore they will not be described in detail herein.

### Example 2—Controller

In the fluid control system 200, the controller 250 is connected (for example, communicatively coupled) to the pressure sensor 220 and to the pump 212. The controller 250 is configured to receive measurements of pressure of the gas in the reservoir 214 from the pressure sensor 220 and configured to control a quantity of the gas displaced in the connecting tube 210 based on measurements of pressure of the gas in the reservoir 214.

The controller 250 controls the quantity of the gas carried into or out of the fluid control system 200 by controlling the operation of the pump 212 based on measurements sent from the pressure sensor 220 to the controller 250. For example, the controller 250 can control the pump 212 to continue pumping gas into the reservoir 214 until a target pressure P1 is received. In one exemplary implementation, the controller 250 is a proportional-integral-derivative controller (PID) controller.

The controller 250 of fluid control system 200 can be configured to determine and/or control one or more of the following parameters:

| Symbol | Parameter description |
|---|---|
| n | Quantity of gas displaced by control system, |
| | measured in moles |
| V_{d} | Volume of gas displaced by control system |
| | (Volumetric gas displacement), measured in |
| | cubic meters, m³, (or litres) |
| Q | Volumetric flow rate of gas in the connecting tube, |
| | measured in m³/s |
| Pᵣ | Pressure of gas in the reservoir, measured in Pascals |
| | (or mbar) |
| Pₛ | Pressure of gas in the connecting tube, measured in |
| | Pascals (or mbar) |
| Tᵣ | Temperature of gas in the reservoir, measured in K |
| Tₛ | Temperature of gas in the connecting tube, measured in K |

According to the ideal gas law,

PV=nRT
Where:
   P is pressure
   V is volume
   n is the number of moles
   R is the universal gas constant
   T is temperature (K)

This means that the quantity of gas, n, (measured in moles) in the reservoir 214 depends on:

$$n = \frac{{P}_{r} {V}_{r}}{{RT}_{r}}$$

Thus, the quantity of gas displaced by the fluid control system 200 (e.g. carried into or out of the system 200 along the connecting tube 210) depends on the change in pressure of the gas in the reservoir 214 and on the storage volume, Vᵣ, of the reservoir 214.

In general, the controller 250 can determine (and/or control) the quantity of gas displaced using the following relationship:

Δn=f₁(Vᵣ,ΔPᵣ,Tᵣ)

Furthermore, the controller 250 can determine (and/or control) a volumetric gas displacement, V_{d}, achieved by the system 200. This is given by:

$$Δ {V}_{d} = {f}_{2} ( {V}_{r} , Δ {P}_{r} , {T}_{r} , {P}_{s} , {T}_{s} )$$

By taking a time derivative of pressure, a volumetric gas flow rate, Q, can be calculated. The volumetric gas flow rate can be determined and/or controlled using the following relationship:

$$Q = {f}_{3} ( {V}_{r} , \frac{{dP}_{r}}{dt} , {T}_{r} , {P}_{s} , {T}_{s} )$$

Where dPᵣ/dt is the rate of change in pressure of the gas in the reservoir 214.

In the above equations, f₁ and f₂ and f₃ are functions that can be determined by, for example, testing and calibration of the system. Alternatively, functions f₁ and f₂ and f₃ are pre-set, e.g. using the ideal gas law. Some parameters are usually determined by design or calibration, for example the volume, Vᵣ, of the reservoir 214.

The system 200 of FIG. 2 does not include a temperature sensor, nor does it include a sensor for measuring the pressure of gas in the connecting tube, Pₛ. In the absence of such sensors, temperatures Tᵣ and Tₛ can be determined by calibration, estimation or by receiving a measurement from an external component. In many applications, Tᵣ and Tₛ can be assumed to be a constant. Also, the pressure of gas in the connecting tube, Pₛ, can be assumed to be atmospheric pressure, or determined from measurement provided by an external system in fluid communication with the connecting tube 210.

In this example, the storage volume, Vᵣ, of the reservoir 214 is constant, and saved in memory by the controller 250.

In some examples, none of the parameters Tᵣ and Tₛ and Pₛ are explicitly determined, especially when the functions f₁ and f₂ and f₃ are determined through calibration.

In order to control the fluid control system 200, for example by controlling any of the parameters Pᵣ, n, V_{d}, Q, in accordance with the equations above, the controller 250 is configured to output control signals to the pump 212 (e.g. control signals which control the power supplied to the pump 212). The control signals may be determined by the controller 250 using the equations above—for example the controller 250 can allocate a particular value of Pᵣ, n, V_{d} or Q as a setpoint, and control the pump 212 to achieve the setpoint (e.g. based on PID control).

The predictable relationship between Pᵣ, and V_{d} (and between Pᵣ, and n) means that the fluid control system 200 is able to displace a predefined volume (and/or quantity) of gas in the connecting tube 210. This is particularly useful for operations which would normally involve a syringe pump, such as aspirating and dispensing.

### Example 3—Leak-Back Connection

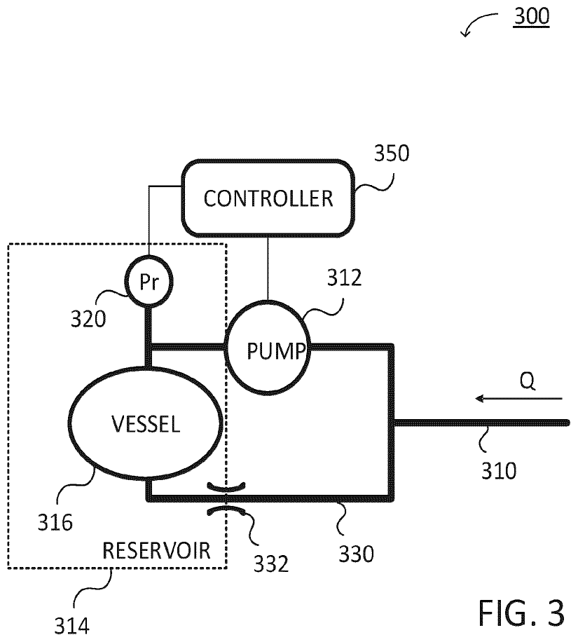

FIG. 3 schematically illustrates a fluid control system 300 according to a further example. The fluid control system 300 includes a connecting tube 310, a pump 312, a vessel 316, a pressure sensor 320 and a controller 350. These components are similar to those described above and therefore they will not be described in detail herein.

In this example, the fluid control system 300 additionally includes a leak-back connection 330. The leak-back connection 330 allows the pressure in the reservoir 314 to be controlled more effectively by allowing gas to leak back from the reservoir 314 to the connecting tube 310. This means that gas has an additional leak-back path, rather than just relying on pump leak-back (if present). For example, where a target pressure in the reservoir 314 is to be achieved, the controller 350 can adjust to correct for overshoot more quickly when the target pressure is surpassed, as the leak back connection 330 allows faster reduction of the pressure in the reservoir 314.

The leak-back connection 330 also helps optimise performance of the fluid control system 300. Generally, best operation of the pump 312 is achieved when the pump 312 is not running near its minimum or maximum operating parameters. It will be appreciated that if the reservoir 314 is fully sealed, the pump 312 may only need to run at a very low power in order to achieve a desired pressured. Pᵣ. Therefore, including the leak-back connection 330 means that the pump 312 can be operated closer to its optimum load (e.g. “mid-loadline”) for improved performance.

The leak-back connection 330 provides a second channel, which connects the reservoir 314 to the connecting tube 310 and which bypasses the pump 312. The leak-back connection 330 includes a flow restrictor 332 which provides a flow restriction to a flow of gas between the reservoir 314 and the connecting tube 310. The flow restrictor 332 is configured to support a pressure difference between the reservoir 314 and the connecting tube 310 while the pump 312 is operating. The flow restrictor 332 can provide a fixed or variable flow restriction, e.g. using a valve, which in some examples can be known and/or controlled by the controller 350. The flow restrictor 332 may comprise one or more orifices though which the gas must flow in order to pass through the flow restrictor 332. Such an orifice may, for example, have a diameter of between 1 μm and 1000 μm. The flow restrictor 332 may comprise one or more plates in which the one or more orifices are respectively provided.

Although referred to as a “leak-back” connection, the second channel 330 preferably provides controlled equalisation (or partial equalisation) between the pressures in the reservoir 314 and the connecting tube 310 regardless of whether the difference is positive or negative. Alternatively, the flow restrictor 332 may comprise an adjustable restriction such as a proportional valve.

### Example 4—Second Pressure Sensor

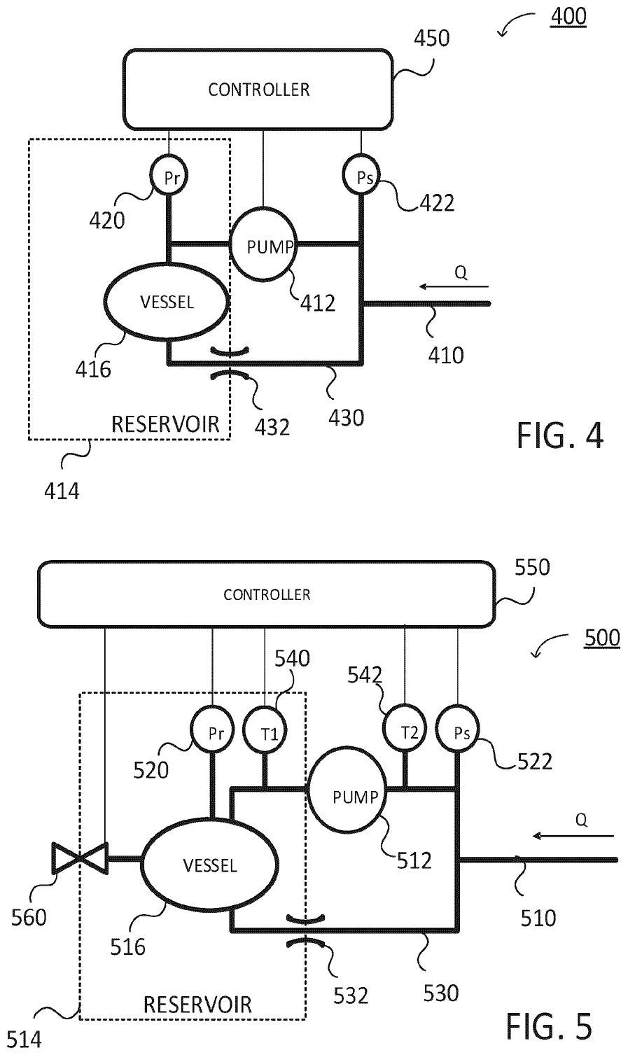

FIG. 4 schematically illustrates a fluid control system 400 according to a further example. The fluid control system 400 includes a connecting tube 410, a pump 412, a vessel 416, a pressure sensor 420, a leak-back connection 430 and a controller 450. These components are similar to those described above and therefore they will not be described in detail herein. In this example, the fluid control system 400 additionally includes a second pressure sensor 422.

The second pressure sensor 422 is arranged to measure a pressure of the gas in the connecting tube 410. The controller 450 of the fluid control system 400 is connected to the second pressure sensor 422 and configured to control the pump 412 based on either or both of the pressure measurements—the pressure of the gas in the connecting tube 410, and the pressure of the gas in the reservoir 414 which is measured by the first pressure sensor 420.

Advantageously, including the second pressure sensor 422 allows a determination of a pressure of gas in the connecting tube, Pₛ, which can be used to determine a pressure of gas in an external system to which the fluid control system 400 is connected. For example, the fluid control system 400 may be connected to a pipette order to control an aspiration and/or dispensing function. The second pressure sensor 422 can indicate to the controller 450 how the pipette is performing. For example, if the fluid control system 400 is using gas as a working fluid to draw a highly viscous liquid into the pipette, there may be a lag between the pressure of gas in the reservoir, Pᵣ, increasing and the full aspiration of the liquid into the pipette. In this case, the second pressure sensor 422 will detect a negative pressure of gas in the connecting tube, Pₛ, indicating a negative pressure of the external system, until the liquid has been aspirated into the pipette.

By virtue of including the second pressure sensor 422, the controller can use a control loop which is based on the pressure of gas in the reservoir, Pᵣ, the pressure of gas the connecting tube, Pₛ, or a combination of the two. This can allow improved control, such as more consistent values of air pressure in the external system.

### Example 5—Venting Valve and Temperature Sensors

FIG. 5 schematically illustrates a fluid control system 500 according to a further example. The fluid control system includes a connecting tube 510, a pump 512, a vessel 516, a first pressure sensor 520, a second pressure sensor 522, a leak-back connection 530 and a controller 550. These components are similar to those described above and therefore they will not be described in detail herein. In this example, the fluid control system 500 additionally includes a first temperature sensor 540 and a second temperature sensor 542 as well as a venting valve 560. By including temperature sensors 540, 542 in the fluid control system 500, the controller 550 can more accurately control and/or determine a quantity of gas being displaced by the fluid control system 500.

The first temperature sensor 540 is provided as part of the reservoir 514. This first temperature sensor 540 provides a measurement of the temperature of gas held in the reservoir 514, for example the temperature of the gas in the vessel 516. The second temperature sensor 542 is connected to the connecting tube 510, generally near or at the inlet of the pump 512. The second temperature sensor 542 provides a measurement of the temperature of the gas in the connecting tube 510.

The first temperature sensor 540 and the second temperature sensor 542 are connected to the controller 550, which is configured to determine and/or control the quantity of gas displaced based on the temperature of the gas in the connecting tube 510 and/or the reservoir 514.

The reservoir 514 of the fluid control system 500 includes a venting valve 560 which is in fluid communication with (e.g. fluidly connected to) the vessel 516. The venting valve 560 is configured to provide an outlet from the reservoir 514 into an external environment, for example the ambient environment, or an external system such as a large volume tank. The venting valve 560 allows gas to pass from the reservoir 514 to the external environment without passing through the connecting tube 510. This means that the pressure in the reservoir 514 can be quickly brought towards equilibrium with the external environment. Typically, the connecting tube 510 is at a pressure which is close to or the same as the air pressure of external environment.

The venting valve 560 is preferably a driven valve. The venting valve 560 is connected to the controller 550 and the controller 550 can control the venting valve 560 to place it in closed or open state. In some implementations, the controller 550 can precisely control the venting valve 560 to a chosen flow restriction, for example a partially open state. This allows control of the rate at which the pressure of gas in the reservoir, Pᵣ, is equilibrated with the external environment to minimise sudden changes in the system which may impact the system control scheme (e.g. the PID loop).

In an example of operation, when the gas in the reservoir 514 approaches the maximum pressure which can be achieved by the pump 512, the pressure in the reservoir 514 can be brought back down to a lower pressure by opening the venting valve 560 to reduce the demand on the pump 512.

By including a venting valve 560 in the flow control system 500, it is possible to achieve a continuous unidirectional flow rate in the connecting to 510. This is described in more detail below.

In another example the venting valve 560 may be a passive, or pressure piloted valve which allows the reservoir 514 to be vented when the pressure reaches a predefined setpoint, or in response to another stimulus, such as a sudden reduction in pressure generated by the pump 512.

### Example 6—Plurality of Vessels

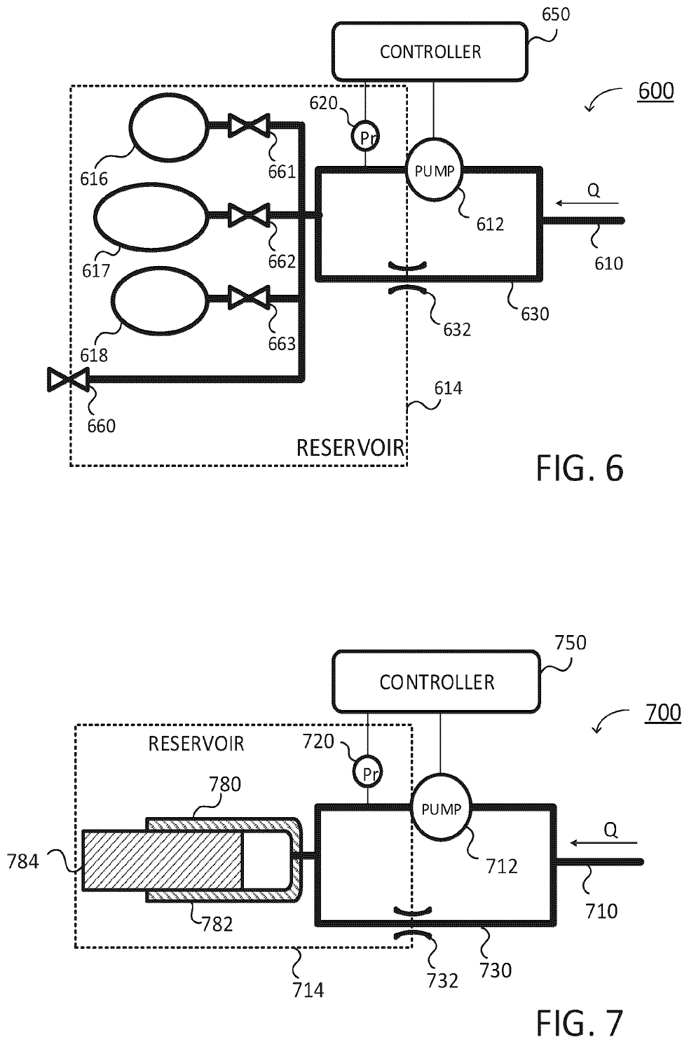

FIG. 6 schematically illustrates a fluid control system 600 according to a further example. The fluid control system 600 includes a connecting tube 610, a pump 612, a pressure sensor 620, a leak-back connection 630 with a flow restrictor 632 and a controller 650. These components are similar to those described above and therefore they will not be described in detail herein. In this example, the fluid control system additionally includes a plurality of vessels 616, 617, 618. Providing a plurality of vessels means that the reservoir 614 has a configurable storage volume, Vᵣ.

As shown in FIG. 6, the reservoir 614 comprises a plurality of vessels 616, 617, 618 each of which is fluidly connected to the fluid control system 600 via a respective valve 661, 662, 663. For each of the vessels 616, 617, 618, when its respective valve 661, 662, 663 is open, the vessel is fluidly connected to the reservoir 614, and therefore the total storage volume, Vᵣ, includes the volume of the vessel. On the other hand, a vessel does not contribute to the total storage volume, Vᵣ, when its respective valve is closed.

In the example shown in FIG. 6, the maximum storage volume, Vᵣ, occurs when all three of the valves 661, 662, 663 are open, and the minimum storage volume, Vᵣ, occurs when all three of the valves 661, 662, 663 are closed. In this way, the storage volume, Vᵣ, of the reservoir 614 can be configured by opening or closing one or more of the valves 661, 662, 663.

In this example, each of the valves 661, 662, 663 can be operated by a user in order to configure a desired storage volume, Vᵣ, of the reservoir 614. However, in other examples, each of the valves 661, 662, 663 may be connected to the controller 650, where the controller 650 can be configured to control each of the valves 661, 662, 663 in order to set a total reservoir storage volume, Vᵣ.

Providing a reservoir 614 with a configurable storage volume, Vᵣ, advantageously allows the sensitivity and capacity of the fluid control system 600 to be adjusted. In general, a reservoir 614 having smaller storage volume, Vᵣ, results in a fluid control system which is more sensitive, however, having a smaller storage volume, Vᵣ, also means that the maximum volume of gas which can be displaced by the system is lower, because the pump 612 has a maximum pumping pressure.

Once the pump 612 is operating at its maximum pumping pressure, the pressure in the reservoir 614 can no longer be changed (e.g. increased). To some extent, this can be alleviated using the venting valve 660 which is in fluid communication with the vessels 616, 617, 618 of the reservoir 614. The venting valve 660 can decrease a pressure difference between the gas in the reservoir 614 and the connecting tube 610. This means that the pumping power required to continue pumping gas into (or out of) the reservoir 614 is decreased.

### Example 7—Precisely Adjustable Vessel Volume

FIG. 7 schematically illustrates a fluid control system 700 according to a further example. The fluid control system 700 includes a connecting tube 710, a pump 712, a pressure sensor 720, a leak-back connection 730 with a flow restriction 732 and a controller 750. These components are similar to those described above and therefore they will not be described in detail herein. In this example, the fluid control system 700 includes a reservoir 714 which has a precisely adjustable vessel 780.

As shown the FIG. 7, the vessel 780 comprises a barrel 782 and a plunger 784, where the plunger 784 is received by the barrel 782 in a syringe-like arrangement. The plunger 784 can be moved in and out of the barrel 782 in order to change the storage volume of the vessel 780 in which gas can be stored. This in turn adjusts the total storage volume, Vᵣ, of the reservoir 714. The plunger 784 can be articulated relative to the barrel 782 by any appropriate mechanism, for example a motor-powered lead screw. In a further example, a stepper motor can be used to push or pull the plunger 784 by a specified distance. Once a storage volume has been set, the vessel 780 maintains a consistent storage volume for any pressure of gas in the reservoir, Pᵣ, for example by virtue of a lead screw arrangement, using components to secure the barrel 782 and plunger 784 relative to one another, or by any other suitable means.

The storage volume of the vessel 780 may be controlled by the controller 750 (e.g. by controlling a stepper motor). In other examples, the storage volume of the vessel 780 may be controlled by a user and/or external component. Any arrangement of the vessel 780 which allows fine adjustment of the storage volume of the vessel 780 can be provided.

The system shown in FIG. 7 advantageously allows active and precise adjustment of the storage volume of the vessel 780.

### Example 8—System Connected to Gas-Liquid Interface

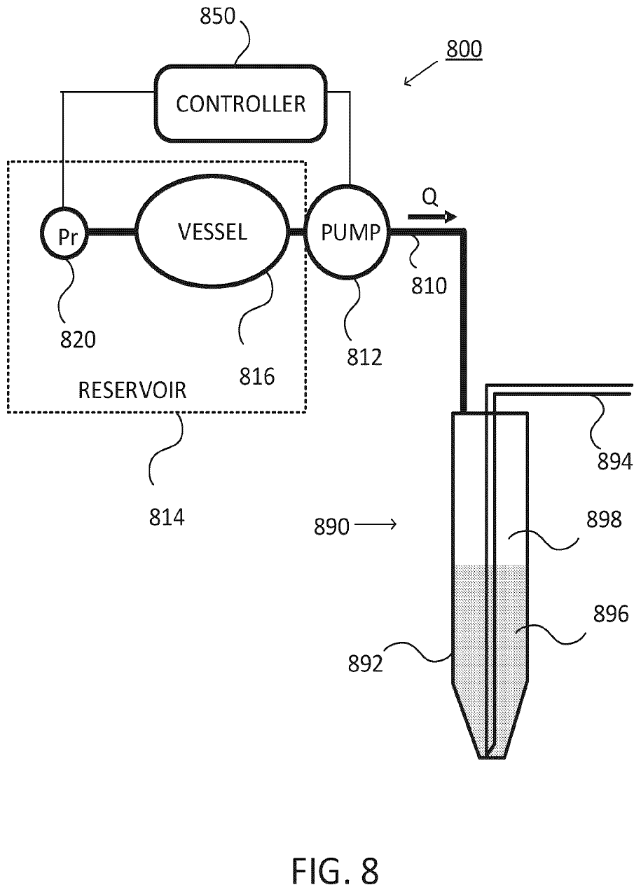

FIG. 8 schematically illustrates a fluid control system 800 according to a further example. The fluid control system 800 includes a connecting tube 810, a pump 812, a vessel 816, a pressure sensor 820 and a controller 850. These components are similar to those described above and therefore they will not be described in detail herein. In this example, the fluid control system 800 is in fluid communication with a gas-liquid unit 890. The gas-liquid unit 890 operates as an interface between gas and liquid, allowing gas flow to be transformed into liquid flow.

As shown in FIG. 8, the connecting tube 810 is connected to the gas-liquid unit 890, in order that gas can be carried between the fluid control system 800 and the gas-liquid unit 890. The gas-liquid unit 890 comprises an gas-tight container 892 which holds a supply of liquid 896 and which also includes a headspace 898 into which gas can be exchanged with the fluid control system 800 via the connecting tube 810. The gas-liquid unit 890 includes a liquid-carrying tube 894 which carries the liquid 896 into or out of the gas-liquid unit 890.

In the system of FIG. 8, the pump 812 is arranged to pump gas from the reservoir 814 and into the gas-liquid unit 890, via the connecting tube 810. This allows the fluid control system 800 to control a flow of liquid in the liquid-carrying tube 894.

As the pump 812 pumps gas into the gas-liquid unit 890, the gas in the headspace 898 exerts an increased pressure on the liquid 896. This results in liquid being forced into the liquid-carrying tube 894.

The controller 850 is configured to control the displacement of gas in the connecting tube 810, and thus control the flow of liquid in the liquid carrying tube 894. The controller 850 achieves this based at least on measurements of the pressure in the reservoir 814. As the pump 812 is controlled to pull gas from the reservoir 814, the controller 850 monitors the resulting decrease in pressure in the reservoir 814 as measured by the pressure sensor 820.

The controller 850 can cause the pump 812 to pump gas out of the reservoir 814 in order to create a flow of liquid out of the gas-liquid unit 890. Once a target pressure in the reservoir 814 is achieved, the controller 850 controls the pump 812 to maintain a constant pressure in the reservoir, and thus stop the flow of liquid 896. At this point, the reservoir is at a negative pressure (relative to the pressure in the headspace 898 and/or atmospheric pressure). Therefore, the flow control system 800 can create a reverse flow of liquid back into the unit 890 by slowing or stopping the pumping of the pump 812 such that the pressure in the reservoir 814 increases back towards atmospheric pressure.

### Example 9—System Connected to Pipette

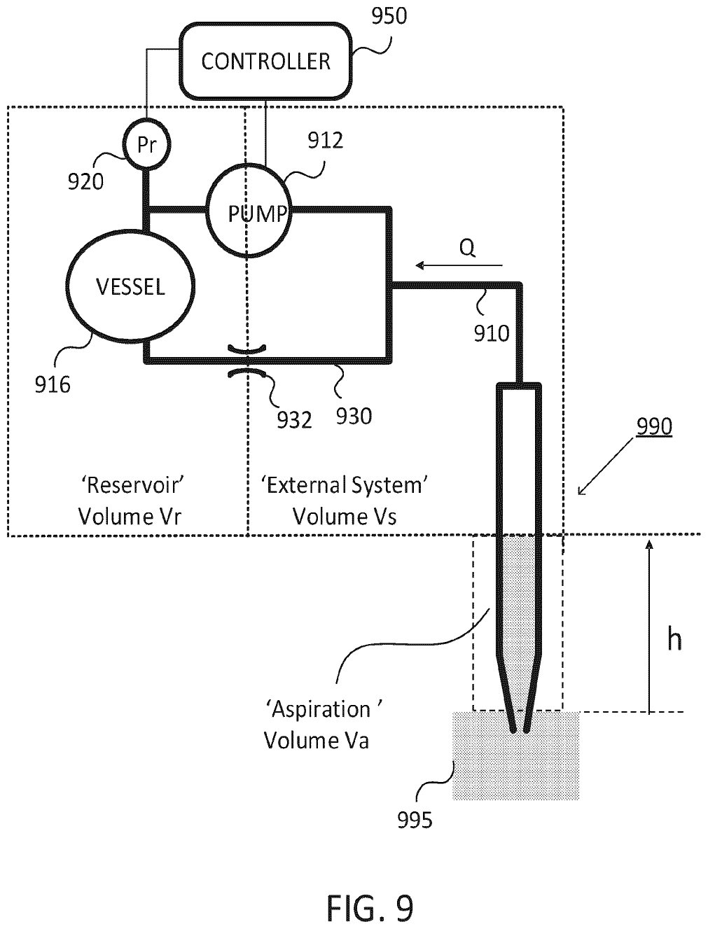

FIG. 9 schematically illustrates a fluid control system 900 according to a further example. The fluid control system 900 includes a connecting tube 910, a pump 912, a vessel 916, a pressure sensor 920, a leak-back connection 930 with a flow restriction 932 and a controller 950. These components are similar to those described above and therefore they will not be described in detail herein.

In this example, the fluid control system 900 is in fluid communication with a pipette 990. As shown in FIG. 9, the pipette 990 is connected to the fluid control system 900 via the connecting tube 910. The controller 950 can control the pipette 990 to perform aspirate and dispense operations, which involves drawing a precise amount of liquid into the pipette 990 from a liquid reservoir 995.

Control of the pipette 990 can involve some or all of the following parameters:

| Symbol | Parameter description |
|---|---|
| Vᵣ | Storage volume of the reservoir, measured in m³ |
| Vₛ | Volume of the external system, including the volume |
| | of the fluid control system on the external |
| | side of the pump and the flow restriction |
| | (may not be well known), measured in m³ |
| Vₐ | Aspiration volume. Volume of fluid aspirated in |
| | Aspirate/Dispense operation, measured in m³ |
| A | Pipette internal cross sectional area, measured in m² |
| Pₛ | Pressure of gas the connecting tube, measured in |
| | Pascals (or mbar) |
| Pₐₜₘ | ambient (or atmospheric) pressure in the environment |
| | where the fluid control system is located, |
| | measured in Pascals (or mbar) |
| h | Fluid height above reservoir surface (where typically |
| | Vₐ = Ah), measured in m |
| ρ | density of the fluid, measured in kg/m³ |
| g | acceleration due to gravity, which has a value of 9.8 m/s² |

Using the ideal gas law, and assumption that temperature is constant, the controller can calculate the change in pressure of gas in the reservoir, ΔPᵣ, required to displace a particular aspiration volume, Vₐ.

$$Δ {P}_{r} = \frac{1}{{V}_{r}} ( {P}_{atm} ( {V}_{r} + {V}_{a} ) + \frac{ρ g}{A} ( {V}_{a} {V}_{s} - {V}_{a}^{2} ) )$$

In many applications, the ρg term is small and can be ignored. In these cases, the aspiration volume, Vₐ, is the same as a volume of gas displaced, V_{d}.

It will be appreciated that the change in pressure of gas in the reservoir, ΔPᵣ, required to displace a particular aspiration volume, Vₐ, can be determined in different ways, and may depend on the design of the external system. For example, more generally, the controller may calculate the change in pressure of gas in the reservoir, ΔPᵣ, required to displace a particular aspiration volume, V_{d}, based on a function:

ΔPᵣ=f₄(Pₐₜₘ,Vᵣ,Vₐ,ρ,A,Pₛ)

Where f₄ can be determined by, for example, testing and calibration of the system.

In examples where the fluid control system includes a temperature sensor, the temperature of gas in the system can also be taken into account, applying the ideal gas law. Also, although this example depicts a liquid being drawn into the pipette, it will be appreciated that the fluid control system can be used to aspirate and dispense any fluid (e.g. a gas).

### Example of Operation—General

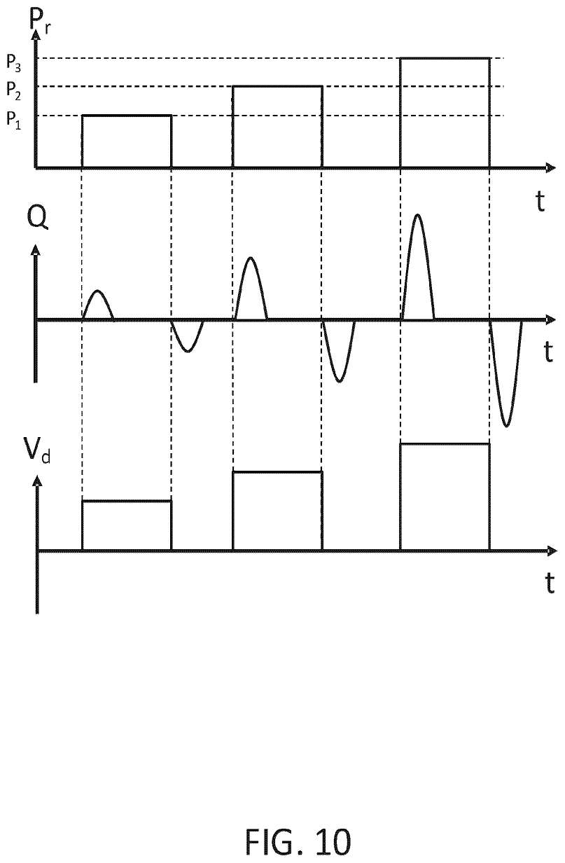

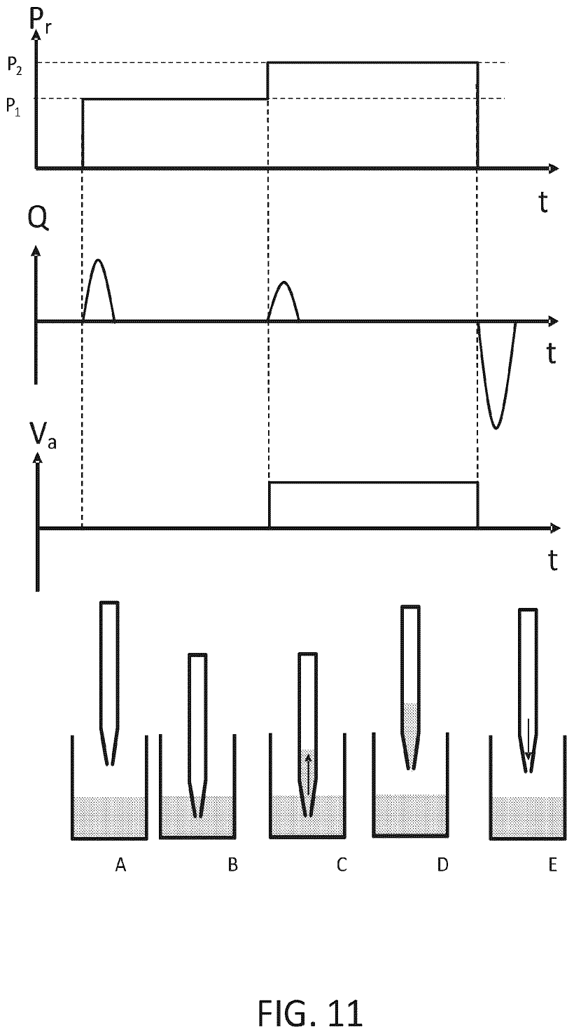

FIG. 10 depicts three simplified, corresponding graphs illustrating operation of the fluid control system according to any of the examples described herein.

FIG. 10 includes a pressure trace, showing how the pressure in the reservoir, Pᵣ, is set, by the controller, to three different pressures P₁, P₂ and P₃ at successive times, in which P₁<P₂<P₃. Between each pressure P₁, P₂ and P₃, the pressure of gas in the reservoir, Pᵣ, falls back to its baseline (which may be 0 or ambient pressure).

Below the plot of pressure of gas in the reservoir, Pᵣ, the corresponding behaviour of the volumetric flow rate of gas, Q, and volume of gas displaced, V_{d}, through the connecting tube is plotted against time.

It can be seen that each increase in pressure results in a corresponding pulse (e.g. increase and decrease) of Q, and each decrease in pressure results in a corresponding negative pulse of Q. The bigger the change in pressure, the bigger the corresponding pulse.

The volume of gas displaced, V_{d}, is proportional to change in pressure. Therefore, the volume, Vₐ of gas stored in the reservoir can be precisely known by the controller, based on the pressure Pᵣ. The system therefore provides a simple way for set volumes (referred to as volume “slugs”) to be displaced (e.g. carried into or out of the system) based on the pressure Pᵣ.

FIG. 10 shows how precise the volume of gas displaced, V_{d}, can be achieved without use of a flow meter in the connecting tube or external system.

FIG. 10 also shows how storage of gas in the reservoir also allows this gas to be leaked back into the system, allowing for some degree of reversible flow. The gas may be air, for example.

### Example of Operation—Aspirate and Dispense

FIG. 11 shows a similar series of simplified graphs to FIG. 10, in this case illustrating an aspirate and dispense procedure controlled by the controller. Rather than the volume of gas displaced, V_{d}, being shown, the volume of fluid aspirated, Vₐ, is shown (in this example, the fluid is a liquid). The procedure can be described as stages A to E.

Stage A: The pipette tip is held out of the liquid in the liquid reservoir, and the pressure of gas in the reservoir, Pᵣ, is controlled to P₁ to “prime’ the reservoir (this allows the dispense volume to be greater than the aspiration volume, to aide “blow-out” of the liquid). A corresponding positive flow Q is associated with the increased pressure.

Stage B: The pipette is lowered into liquid whilst maintaining P₁ in the reservoir.

Stage C: The pressure of gas in the reservoir, Pᵣ, is set to P₂. The aspiration volume, V_{d}, is based on ΔPᵣ=P₂−P₁ using equation:

$$Δ {P}_{r} = \frac{1}{{V}_{r}} ( {P}_{atm} ( {V}_{r} + {V}_{a} ) + \frac{ρ g}{A} ( {V}_{a} {V}_{s} - {V}_{a}^{2} ) )$$

Stage D: Withdrawal of pipette from liquid. The liquid is held in pipette and thus no liquid flow occurs.

Stage E: Pᵣ is controlled to 0 (or its starting pressure) in order to fully dispense the liquid and stored gas (referred to as “blow-out”). Controlling the rate of change of Pᵣ, and hence the dispensing rate, helps to control the liquid dispense process, for example to avoid ‘spitting’ or turbulent dispense of the liquid, while using “blow-out” minimises liquid being left in the pipette.

In Stage E, other options include setting Pᵣ to P₁+ (P₂−P₁)/2 or any other fraction in order to dispense a corresponding fraction of the liquid with no “blow-out”.

### Example of Operation—Ramping Pressure

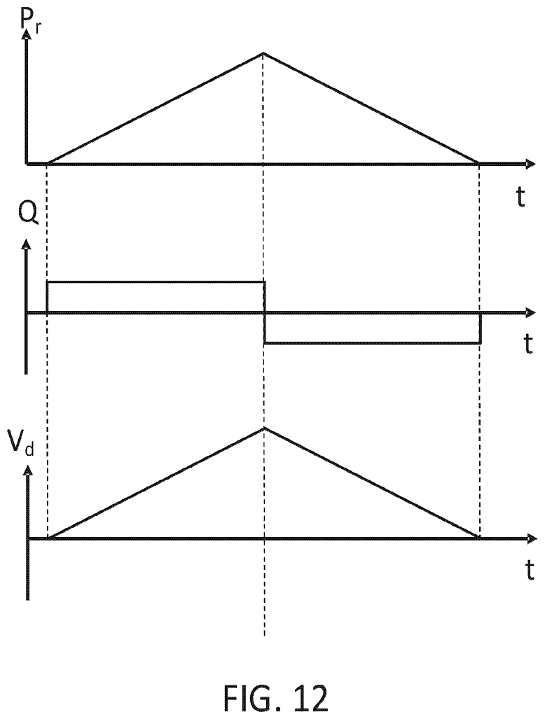

FIG. 12 shows a series of simplified corresponding graphs which illustrate how directional volumetric flows can be achieved. These graphs show how pressure of gas in the reservoir, Pᵣ, volumetric flow rate Q and volume of gas displaced, V_{d}, change with time.

As can be seen, a pressure increase at rate dPᵣ/dt results in a positive flow, Q, given by:

$$Q = \frac{{V}_{r}}{{P}_{atm}} \frac{{dP}_{r}}{dt}$$

As pressure is reduced (e.g. to 0 corresponding to Pₐₜₘ), at rate −dPᵣ/dt this results in a negative flow Q.

The volume of gas displaced V_{d} varies proportionally with Pᵣ, as shown in the lower graph.

### Example of Operation—Continuous Volumetric Flow Rate of Gas

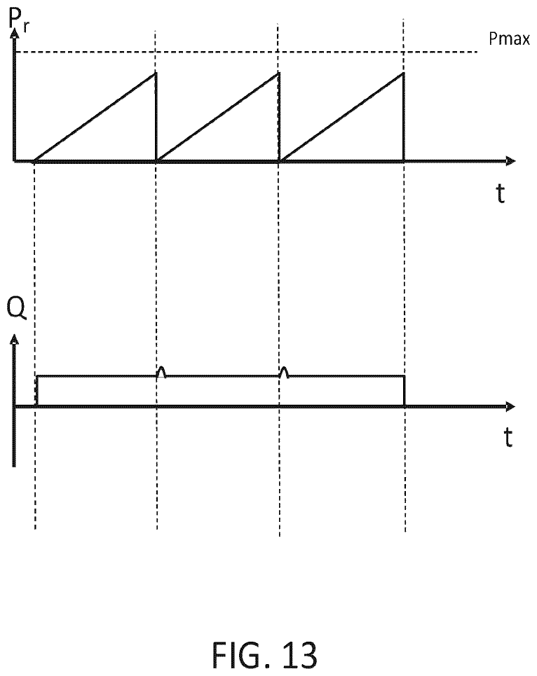

FIG. 13 shows two simplified corresponding graphs which illustrate how a continuous volumetric flow rate of gas can be achieved. This is done using a flow control system which includes a venting valve.

FIG. 13 shows two corresponding graphs against time—pressure of gas in the reservoir, Pᵣ, and flow rate, Q. It can be seen that pressure of gas in the reservoir, Pᵣ, is initially increased at rate dPᵣ/dt (the time derivative of Pᵣ). As the pressure approaches a threshold—in this case maximum pressure Pₘₐₓ—the venting valve is opened by the controller. This causes the pressure in the reservoir to return to 0 (or starting/ambient pressure). The valve can be closed and then the pressure of gas in the reservoir, Pᵣ, can then be again increased at rate dPᵣ/dt. Alternative criteria for opening the venting valve may be used, including fixed timings, pump drive power or external signals which may indicate preferable timings for the pressure vent.

The pressure of gas in the reservoir, Pᵣ, and venting control also leads to a substantially constant flow rate, as shown in the graph of Q against time. Due to the venting operation, there may be inconsistencies (or ‘blips’) in the flow rate, however these are typically small. Also, such blips can be mitigated by controlling the extent to which the venting valve is open, changing the control mode during the venting operation or by the controller applying a slower control loop controlling a ‘fixed’ pressure of gas in the connecting tube, Pₛ, which is informed by the measured gradient of Pᵣ and can be used to determine a pressure of gas in the external system.

It is noted that near-continuous flow rates can also be achieved without the presence of a venting valve. In FIGS. 6 and 7, the reservoir includes means for changing the storage volume, Vᵣ, of the reservoir. This can allow control of the pressure—for example opening one of valves 661, 662, 663 of the fluid control system in FIG. 6 will increase the storage volume, Vᵣ, and therefore decrease the pressure of gas in the reservoir, Pᵣ. Similarly, actuating the plunger in the vessel of FIG. 7 will also increase the storage volume, Vᵣ, of the reservoir and therefore decrease the pressure of gas in the reservoir, Pᵣ.

### Modifications and Alternatives

### General

It will be understood that the present disclosure has been described in relation to its preferred embodiments and may be modified in many different ways without departing from the scope of the present disclosure as defined by the accompanying claims.

The fluid control system is preferably adapted for controlling a flow of air, however it can be adapted for use with other gases (for example any gas which obeys the ideal gas law).

The term “reduced pressure” as used herein generally refers to a pressure less than the ambient pressure where the pump is located. Although the term “vacuum” and “negative pressure” may be used to describe the reduced pressure, the actual pressure reduction may be significantly less than the pressure reduction normally associated with a complete vacuum. The pressure is “negative” in the sense that it is a gauge pressure, i.e., the pressure is reduced below ambient atmospheric pressure. Unless otherwise indicated, values of pressure stated herein are gauge pressures and a pressure of 0 corresponds to ambient atmospheric pressure.

The pipette may instead be a syringe, needle, or any other element capable of being used to aspirate and dispense liquid (or other fluid), as the same principle of operation applies.

The fluid control system may be configured to generate a positive rate of change of pressure of the gas in the reservoir to control an aspirating rate of a pipette which is in fluid communication with the first channel.

The fluid control system may be configured to generate a negative rate of change of pressure of the gas in the reservoir to control a dispensing rate of a pipette which is in fluid communication with the first channel.

### Connecting Tube

In some examples, the connecting tube is connected to an outlet of the pump, or an inlet/outlet port of the pump in examples where the pump is reversible.

In further examples, the fluid control system does not include a connecting tube. In this case, the channel for carrying gas in and out of the fluid control system is the inlet/outlet port of the pump.

Where the fluid control system is being used to control the flow of liquids, the connecting tube may receive liquid along at least some of its length. Ideally, liquid is not drawn into the pump or reservoir.

Although described as a tube, the connecting tube may comprise any element which acts as a channel for carrying air (or any gas) into or out of the fluid control system.

Additional components may be added to the connecting tube to aide functionality, including, but not limited to: filters, fluid traps, valves, torturous paths to prevent liquid ingress.

In general, the connecting tube is at atmospheric pressure.

### Pump

The pump may be a highly controllable air pump—e.g. an acoustic resonance pump or similar. However, any pump or plurality of pumps can be used. The pump may instead comprise any suitable pump, in particular a diaphragm pump. Particular benefits associated with using a piezoelectric acoustic resonance pump include the ability to provide high differential pressures with smooth, controllable flow rates.

Although not shown, the system may include a power unit for the pump which may output a periodic waveform to drive a piezoelectric actuator in the pump. This waveform can be controlled by the controller to control the pump operation, based on the methods described herein.

### Reservoir

The reservoir can be attached to the inlet or outlet of the pump, in order to create positive or negative air flows. As stated above, the reservoir volume may be determined via calibration, or alternatively the reservoir volume may be determined from the physical dimensions of its components.

Although the reservoir has been described as including at least one vessel, in some alternative implementations the reservoir can be provided without such a vessel. This is because components of the reservoir such as the pressure sensor and the connecting channels inherently include a volume, albeit small, in which gas can be stored. In some examples, where only a small reservoir volume is desirable to provide a high level of sensitivity, the reservoir does not include a vessel, and its storage volume, Vᵣ, is provided by the volume in the pressure sensor (and/or connecting components such as tubes) in which air can be stored

### Leak-Back Connection

The leak-back connection (also referred to as a bypass channel or second channel) provides a further fluid connection between the reservoir and the connecting tube. A plurality of leak-back connections can be provided. Each of the one or more leak-back connections can include a flow restriction, e.g. provided by a flow restrictor. In some examples, each flow restriction (or flow restrictor) comprises a driven valve which is connected to and controllable by the controller. In some examples, any of the one or more leak-back connections can include multiple components, for example a driven valve and a flow restriction such that different combinations of flow restrictions in the different leak-back connections can be enabled by opening or closing the appropriate driven valves (each of which capable of being controlled by the controller). In some examples, the leak-back connection may include a second pump. A flow restriction can comprise any element which can support a pressure difference between the reservoir and the connecting tube.

The flow restrictor allows the pressure of gas in the reservoir, Pᵣ, to be better controlled by allowing air to leak back around the pump, allowing the pump to run against load (makes PID control easier).

### Sensors

Although the example of a fluid control system shown in FIG. 5 includes two temperature sensors on either side of the pump, it will be appreciated that only a single temperature sensor can be provided.

In further examples, additional sensors can be added to the fluid control system. This includes a humidity sensor, gas composition sensor, etc. The system may include any number of each sensor type to expand functionality or reduce system cost. Such sensors allow determination, by the controller, of additional properties of the gas in the system, in order to provide better control and compensation.

### Controller

The controller has been described herein as being configured to perform steps (e.g. determine and/or control quantity of gas displacement) based on measurements (such as pressure). It will be understood that the wording “based on” is not intended to be limiting, and that any of these disclosed examples can be combined. For example, the controller can be configured to perform any of the described steps based on any combination of Vᵣ, Vₛ, V_{d}, A, Pₛ, Pₐₜₘ, h, p, g, n, V_{d}, Q, Pᵣ, Tᵣ, Tₛ, in accordance with the equations set out above.

As described above, in some examples the system can have limited numbers of sensors, e.g. just a pressure sensor in the reservoir. In this case, the controller may be configured to use simplified control algorithms, such as the following:

$${V}_{d} = {g}_{1} ( {P}_{r} )$$

$$Q = {g}_{2} ( {dP}_{r} / dt )$$

Where functions g₁ and g₂ can be calibrated or pre-set.

The controller can be connected (e.g. communicatively coupled) to any of the components (e.g. the reservoir pressure sensor, the pump, the other sensors) via any suitable connection such as using a wireless connection, or more preferably via electronic circuitry. The fluid control system may be configured such the sensors connected to the controller send measurement signals to the controller, and the controller sends control signals to the pump based on the measurement signals.

In some examples, the controller is additionally or alternatively configured to determine a quantity of the gas carried into or out of the fluid control system by the connecting tube based at least on measurements of pressure of the air in the reservoir. In such examples, the controller may not actively control the pump based on the measurements of pressure of air in the reservoir. Instead, the controller can be configured to output the determined quantity of gas being carried into or out of the fluid control system. The output can be received by external components, such as a computer, and/or presented to a user.

In some examples, the controller can also be configured to determine and/or control the storage volume, Vᵣ, of the reservoir.

If the fluid control system includes a second pressure sensor arranged to measure a pressure of the gas in the connecting tube, the controller can control the pump directly based on the pressure of gas in the connecting tube, Pₛ. This allows a smooth control of external system pressure, which may be substantially equal to the pressure of gas in the connecting tube, Pₛ. In some examples, it is beneficial for the controller to control the pump operation (and optionally venting valve operation) based on a combination of the pressure of gas in the connecting tube, Pₛ, and the time derivative of the pressure of gas in the reservoir, Pᵣ. This can alleviate lag between a change in dPᵣ/dt and fluid movement in external systems with high fluidic restriction and avoids ‘start-up’ issues.

The controller can be provided by multiple separate controllers (separate in hardware and/or software) and may include distributed components. The controller may be included as part of the pump.

The controller may be a computing device, computer, processor, or other processing apparatus. The controller may be formed by several discrete processors.

The controller may further include a network interface device for connecting to an external network. The controller also may include a video display unit (e.g., a liquid crystal display or light emitting diode display), an alphanumeric input device (e.g., a keyboard or touchscreen), a cursor control device (e.g., a mouse or touchscreen), and an audio device (e.g., a speaker).

In one example, the controller includes a processing device (e.g. microprocessor, central processing unit), a main memory (e.g., read-only memory (ROM), flash memory, dynamic random access memory (DRAM) such as synchronous DRAM (SDRAM) or Rambus DRAM (RDRAM), etc.) and a secondary memory (e.g., a data storage device), which communicate with each other via a bus.

The secondary memory may include one or more machine-readable storage media (or more specifically one or more non-transitory computer-readable storage media) on which is stored one or more sets of instructions embodying any one or more of the methodologies or functions described herein. The instructions may also reside, completely or at least partially, within the main memory and/or within the processing device, the main memory and the processing device also constituting computer-readable storage media.

Unless specifically stated otherwise, as apparent from the following discussion, it is appreciated that throughout the description, discussions utilising terms such as receiving, determining, comparing, enabling, maintaining, identifying, applying, transmitting, generating, or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The approaches described herein may be embodied on a computer-readable medium, which may be a non-transitory computer-readable medium. The computer-readable medium may carry computer-readable instructions arranged for execution upon a processor so as to cause the processor to carry out any or all of the methods described herein.

It is to be understood that the above description is intended to be illustrative, and not restrictive. Many other implementations will be apparent to those of skill in the art upon reading and understanding the above description. Although the present disclosure has been described with reference to specific example implementations, it will be recognised that the disclosure is not limited to the implementations described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A fluid control system comprising:
a first channel for carrying a gas in and out of the fluid control system;
a reservoir for said gas, wherein the reservoir comprises a first pressure sensor arranged to measure a pressure of the gas in the reservoir;
a pump for pumping said gas between the first channel and the reservoir;
wherein the system is arranged such that a quantity of the gas displaced in the first channel depends on a change in pressure of the gas in the reservoir.

2. The fluid control system of claim 1, further comprising a controller arranged to be communicatively coupled to the first pressure sensor and configured to determine and/or control a quantity of the gas displaced in the first channel based on a change in pressure of the gas in the reservoir.

3. The fluid control system of claim 2, wherein the controller is configured to determine and/or control the quantity of the gas displaced in the first channel further based on:
a storage volume of the reservoir in which gas can be stored.

4. The fluid control system of claim 2, wherein the controller is configured to determine and/or control a volumetric flow rate of gas in the first channel based on:
a storage volume of the reservoir in which gas can be stored; and
a time derivative of pressure of the gas in the reservoir.

5. The fluid control system of claim 2, wherein the controller is further configured to control the pump based on a change in pressure of the gas in the reservoir, thereby providing control of the quantity of the gas displaced in the first channel.

6. The fluid control system of claim 1, wherein the pump is adapted to displace <0.01 μL of gas per cycle or controllable step.

7. The fluid control system of claim 1, wherein the pump is a piezoelectric acoustic resonance pump.

8. The fluid control system of claim 1, wherein the reservoir comprises at least one vessel arranged to store said gas.

9. The fluid control system of claim 8, wherein the at least one vessel has a configurable storage volume.

10. The fluid control system of claim 9, wherein the at least one vessel comprises a plunger and barrel arrangement in order to provide the configurable storage volume.

11. The fluid control system of claim 9, wherein the reservoir comprises a plurality of vessels each of which is in fluid communication with the fluid control system via a respective valve, such that the storage volume of the reservoir can be configured using the respective valves.

12. The fluid control system of claim 1, further comprising a second channel arranged to provide a fluid connection between the reservoir and the first channel, wherein the second channel provides a flow restriction to a flow of gas between the reservoir and the first channel.

13. The fluid control system of claim 12, wherein the flow restriction provided by the second channel is configured to support a pressure difference between the reservoir and the first channel.

14. The fluid control system of claim 1, further comprising a valve in fluid communication with the reservoir, the valve being configured to control displacement of gas into or out of the fluid control system, without passing through the first channel, in order to decrease a pressure difference between the gas in the reservoir and the gas in the first channel.

15. The fluid control system of claim 2, further comprising at least one temperature sensor for measuring a temperature of the gas, and wherein the controller is further configured to determine and/or control a quantity of the gas displaced in the first channel further based on the temperature of the gas.

16. The fluid control system of claim 2, further comprising a second pressure sensor arranged to measure a pressure of the gas in the first channel:
wherein the controller is communicatively coupled to the second pressure sensor and further configured to control the pump based on measurements of pressure of the gas in the first channel.

17. The fluid control system of claim 1, wherein the fluid control system is configured to displace a predefined quantity or volume of gas in the first channel.

18. The fluid control system of claim 1, wherein the fluid control system is arranged to generate and maintain a pressure difference between the reservoir and the first channel by pumping gas between the reservoir and the first channel.

19. The fluid control system of claim 1, wherein the fluid control system is configured to create a positive or negative rate of change of pressure of the gas in the reservoir in order to cause a positive or negative volumetric flow rate of gas in the first channel.

20. The fluid control system of claim 1, wherein the fluid control system is configured to aspirate a liquid into a pipette which is in fluid communication with the first channel by increasing the pressure of the gas in the reservoir.

21. The fluid control system of claim 20, wherein the fluid control system is configured to control dispensing of the liquid from the pipette by slowing or stopping pumping of the gas from the first channel to the reservoir.

22. A method of controlling a displacement of gas by a fluid control system comprising: a first channel for carrying a gas in and out of the fluid control system; a reservoir for said gas, wherein the reservoir comprises a first pressure sensor arranged to measure a pressure of the gas in the reservoir; a pump for pumping said gas between the first channel and the reservoir; wherein the system is arranged such that a quantity of the gas displaced in the first channel depends on a change in pressure of the gas in the reservoir, the method comprising:
receiving, from the first pressure sensor, measurements of pressure of the gas in the reservoir:
determining a change in pressure of the gas in the reservoir; and
controlling a quantity of the gas displaced in the first channel based on the change in pressure of the gas in the reservoir.

23. The method of claim 22, further comprising:
identifying a storage volume of the reservoir in which gas can be stored; and
controlling the quantity of the gas displaced in the first channel further based on the storage volume of the reservoir.

24. The method of claim 23, further comprising:
determining a time derivative of pressure of the gas in the reservoir, and determining and/or controlling a volumetric flow rate of gas in the first channel based on:
the storage volume of the reservoir in which gas can be stored; and
the time derivative of pressure of the gas in the reservoir.

25. The method of claim 22, further comprising controlling the pump based on the change in pressure of the gas in the reservoir, thereby providing control of the quantity of the gas displaced in the first channel.
